(19) United States
(12) Patent Application Publication
(10) Pub. No.: US 2005/0019741 A1
(43) Pub. Date: Jan. 27, 2005

(54) Method of education and scholastic management for cyber education system utilizing internet

(76) Inventor: Jong-Hae Kim, Pacific Ave. (RU)

Correspondence Address: HOGAN & HARTSON L.L.P., 500 S. GRAND AVENUE, SUITE 1900, LOS ANGELES, CA, 90071-2611, US

(21) Appl. No.: 10/467,520

(22) PCT Filed: Jan. 31, 2002
(86) PCT No.: PCT/KR02/00138

(30) Foreign Application Priority Data
Feb. 8, 2001 (KR) 2001/0006280
Mar. 31, 2001 (KR) 2001/0017240

(51) Int. Cl. G09B 25/00

(52) U.S. Cl. 434/365

(57) ABSTRACT

This invention relates to the method of cyber education through internet capable to check the true attendance of a cyber class by a fingerprint and calculate the accumulative learning time of each registered lectures by the host computer for the scholastic management of the cyber education system. In addition, utilizing this invention, it provides a pre-school system by using a game and animation created for pre-school curriculums capable to evaluate the education development of each children with a method for calculating the accumulative learning time of each subject by individual ID, and a software system for studying subjects at a stage of character formation for kids and evaluating the mental development of human being by means of playing game.

### FIELD OF INVENTION

The present invention relates to the method of cyber education and scholastic management system related to the cyber education through Internet capable to check the true attendance of the cyber class by a fingerprint and calculate the accumulative learning time of each registered lectures by the host computer for determining automatically the completion of program for cyber education's scholastic management.

In addition, utilizing the system that calculates accumulative learning time of each registered lectures by the host computer, a children's educational software program can be created for the pre-school children at the stage of character formation where they start learning language, morality and human nature by imitation on the model of parents and home environment, the system can accumulate how much they absorb knowledge on each subject and how many subjects are covered according to the accumulated learning time data of the each subject by the child's individual ID, to provide the data for evaluating each child's progress in data by the category of each subject, so that the parents may know what kind of the subjects to be covered more for their kids.

### DESCRIPTION OF THE RELATED ART

The conventional way of Internet education is when a student registers for a program, the student receives an ID, attends class with that given ID and takes a form of tests to get grades or get completion of courses.

However, this method can not distinguish the true attendance of the cyber class from the wrong access by the substitutes. Also, when student does not want to be presented at a complete lecture at the same time, attending a part of lecture, the conventional system have a problem with not enough data base information to accumulate actual time spent.

Further, taking advantage of world wide internet, cyber lecture course can be used on a world wide for many different people using different language, and it needs more developed technology rather than administering by human force in order to administer, control and provide the multi language lecture on the same subject by the same professor.

In addition, conventional curriculums for pre-school children courses on Internet have a problem with not providing enough information to evaluate the learning time of each subject according to the curriculums and how much children understand the program by the individual child's ID.

Especially, when a child is registered on a off-line pre-school program, parents do not know how many hours the child spent on what subject, and what area needs to be covered more for the children's human mental development. Just by completing the program, parents assume that their child obtain more knowledge from the school.

Children are imitative by nature and begin to build up their character and temper by recognizing objects, and learning from daily activity of their parents and home environment from the age of 2-3 years old.

It is difficult for the parents to be a standard model for every aspect and subject for providing enough learning experiences for their children, therefore, it needs to develop a software for human brains that provide a progressive learning effect and memorizing the knowledge just like a software for the computer.

Learning experience on the model of parents from childhood helps to develop personality and morality of that person for lifetime so it is crucial that children's learning experience should be from very early stage of their lives.

The conventional ordinary off-line course or on-line course does not provide an accurate information such as what kind of learning experience children absorb and what needs to cover more in order to form a good character and a good disposition.

### SUMMERY OF THE INVENTION

A primary object of the present invention is to resolve prior mentioned problems by when a student registers for Internet course, the student inputs his/her own fingerprint data or iris of the eyes data in school's host computer. When the student begins the class and ends the class, the student is required to put personal data such as fingerprints or an iris of the eyes, then host computer from school compares the data information from the memory mean of host computer to the student's data when he/she inputted to recognize if true person took the lesson.

When a student is taking a course, the host computer calculates data information containing how many hours on each subject the student spent and progress to determine grades and manage educational matters.

Further, regarding the pre-school curriculums that are made by an educational institution, the pre-school curriculums should construct games and animations data to help student to learn by himself by playing the PC, create a ID to log into the system and calculate number of logging time and hours spent on each subject to provide accurate data for parents to understand progress.

Therefore, parents can determine shortage on certain subject and what more needs to be done according to the progressive report data of the host computer.

Also, by given ID for students, the host computer accumulates hours spent on each subject and determines qualification for completion of the program to give out graduation certificates to the educational institution to manage its business.

### BRIEF DESCRIPTION OF THE DRAWING

The figures in the drawings are briefly described as follows:

FIG. 1 is a block diagram of the registering fingerprint data into education management system.

FIG. 2 is a block diagram of the system that calculates logging time on educational institution's database

### DETAILED DESCRIPTION OF THE INVENTION

To overcome the limitations in the prior art describe above, base on understanding and predicting current situation and certain limitation that will occur in the future. In managing cyber institution, the present invention provides a method to verify an accurate attendance and registration by comparing fingerprints or iris of the eyes, and provides a method of scholastic management that cyber institution calculates automatically the true attendance of the cyber class by student's individual ID by a host computer to prevent waste of human source and operating cost by the more accurate and economical managing system.

In addition, utilizing the technology that calculates an accumulative learning time of each registered lectures by the host computer, the present invention is providing a pre-school education system through internet.

The pre-school management can construct a data base program on variety of subjects for pre-school children, and under the guidance of parents, children can log into an access to the program and complete courses. Furthermore, it provides a progressive data by children's ID, and parents can determine what programs are covered and how many hours spend to measure the children's learning stage.

It also provides a technology to construct a software to evaluate the mental development of the children's memory from early stage of learning to form a good character and temper.

It is understood that many modifications and variations can be made therein, without departing from the spirit of the invention and from the scope of the appended claims.

In the following description of the exemplary embodiment, reference is made to the accompanying drawings, which is shown by way of illustrations of specific embodiment in the invention. It is made without departing from the scope of the present invention.

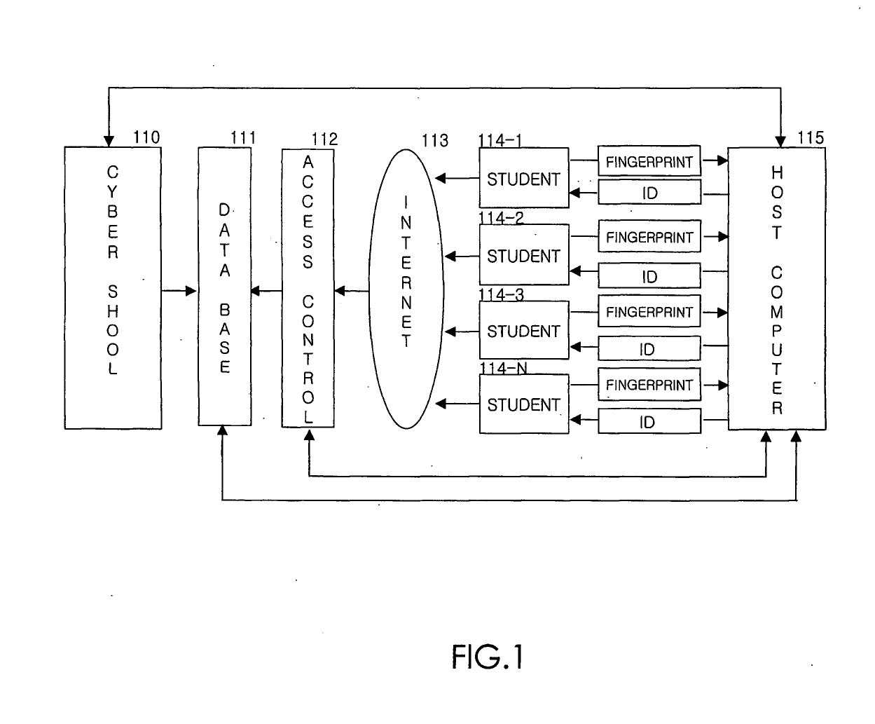

FIG. 1 illustrates a block diagram of the registering fingerprint data into education management system.

According to the illustration of FIG. 1, the invention comprises a cyber educational institution (110); an institution's host computer (115); a data base (111) that stores each subject's lessons as in a form of digital data and controlled by host computer, when students (114-1 to 114-n) log into the data base through internet (113); an access control mean (112) to control fraud by checking ID and fingerprint data For checking attendance, when students (114-l-114-n) registers for the program, student inputs fingerprint to the host computer (115) and receives an ID to log into the data base (111). The host computer then stores registered ID and fingerprint as in a form of digital data to memory.

When a student tries to log into institution's database (111) through the Internet (113) and put the given ID as same as conventional way.

When student wants to log in and try to view a lecture for a subject, the student needs to input fingerprint data through personal computer. Then, the host computer compares the inputted data to the data from the memory. If both of data matches, then, the computer recognizes ID and allows student to access the lecture and stores the data such as the log-in time, the learning time by the subject of the lectures. When the student wishes to end the lecture, with ending alert signal, the student needs to input fingerprint data through personal computer.

Then, host computer (115) compares the inputted data to the data from the memory. If both data matches, then, computer calculates accumulative logging time and store to the memory with ID. In case, if both fingerprint data does not match, the host computer indicates as “ERROR” to the student and asks to re-enter fingerprint If the lecture session is ended or log-off without verifying fingerprint, then host the computer considers as fraud and stores the learning time as for the session.

Also, if the cyber educational institution tries to check constantly for more accurate attendance, set the program for certain set time such as in every 30 min for host computer (115) to transmit a signal to input fingerprint through student's PC monitor and compare the data in the same way.

Further more, if the institution creates a program for 2 hour lecture session and divides lecture into 30 min session or 1 hour session, the student can stop or continue each session for convenient and host computer stores and accumulates session time for each ID automatically and when all the sessions are complete then the host computer can give the grades.

According to the program mentioned above, when a student is complete with all the courses, then host computer accumulates all the credits and notify the student to do finals step or any kind of graduation process such as an examination, or a presentation of a thesis for granting a degree to the student.

If the student finishes the final step through on-line or off-line according to the institution's guideline, then the student is qualified for the completion of courses and granted for a degree.

These steps can be used for public school system, private schools or any kind of educational institutions such as a college, an university and a graduate school.

Also, instead of the fingerprint recognition system, when an iris recognition system or a voice recognition system become popular and economical, the system can be replaced and gets same effects.

Internet is the worldwide source without any borders among countries, when the educational institution want to manage worldwide, construct data base for each subject in different languages according to the professor, when students register and log in with choice of language, subject and professor then institution can check attendance with the prior mentioned systems to manage the institution worldwide.

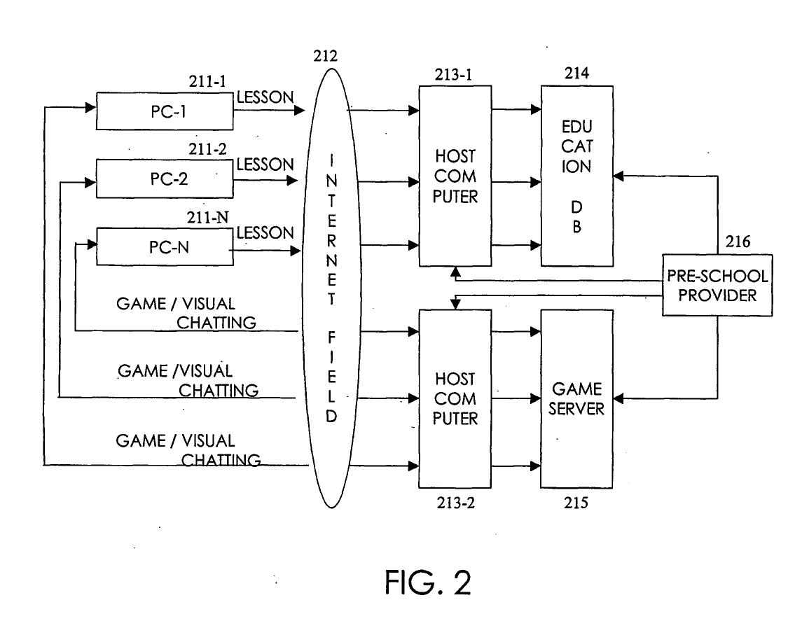

FIG. 2 illustrates the block diagram for a pre school educational system utilizing the technology of the present invention.

According to FIG. 2, the present invention comprises a school (216) for creating and managing a cyber pre-school system; an educational program data base (214) created suitable for constructing the pre-school curriculums by subjects; a host computer (213-1, 213-2) for controlling access to the database by the non-authorized user, and calculating accumulative the learning time and number of log in times and controlling the system; an on-line game server (215) for storing the data of games for students; user's personal computers(211-1, 211-2, - - - 211-n) to log in the data base (214) and the game server (215) through Internet (212).

The database (214) includes a pre-school or a kindergarten's educational curriculums on each subject as a form of games or animations. Each subject is divided to cover all the details on educational program. In addition to the basic programs, a dance program, a music program, a language program, a mathematics program and an honor program can be created and added for the additional education in addition to the pre-school curriculums.

Game server (215) provides children to play game, stores all different kinds of pre-school game programs and provides multi media chatting services.

When student registers to the school (216) then student receives an ID code issue by school to log in to the system including program database (214) and games server (215). Student pays tuition to the school and the tuition is main source of the cyber school's income.

When the student registers a fingerprint for checking attendance the scholastic management of the cyber pre-school can be used for same effects as described prior. Student's parents can link to school's educational program database (214) through internet (212) using their personal computers (211-2, 211-2, - - - 211,n) to view and select each subject and help student to log in.

Educational program database (214) includes each subject's lessons through games, animations, and videos to help understand and teach children who are just starting to learn.

For example, “Christmas” can be put as search word, then children can learn about Christmas, and or “food” can be main search word to explain relationship between human body and food and all related topics. Parents can select certain program if they feel more lessons should be provided certain area for the kids.

If parents select daily curriculums or lessons for children, children can join programs by simply pushing few buttons to play games, watch cartoons and videos and can repeat the programs for greater effects by the progressive learning effect. After finishing with internet lessons, parents can discuss daily subject which children learned and add more explanation to help understand better and this process is reaching the goal of educational program and help children learn step by step.

The host computer (213-1, 213-2) then make data and stores information containing each subject logging time, time spent with user's ID to calculate accumulative time spent and indicate learning progress.

Each completed subject and time spent is stored as data then those stored data can be used for providing and checking completion of the entire program to give out graduation certificate and base for children's progress in learning.

Those stored data can provide and use for checking individual's progress, if parents think there are more area which needs to be covered, it is simple to recognize that information, and from stored data, the school as a service provider can make individual's progress report data for parents for convenience.

Addition to the basic curriculums, an honor program, a dance lessons, a music lessons, a language lessons or a mathematics can be added to the data base (215) for the extra curriculums and more professional lessons. Calculating and checking progress is same as a basic system.

For extra curriculums, the school can provide special certificate for completion of those courses in addition to basic graduation certificate. Off-line or conventional pre-school or kindergarten can join cyber program and instead of parents providing and selecting each subject or course for individual child, off-line school's teacher or guardian can do same part. All data and progress report can provide base for off-line schools to help issue certificates.

Also, when students are log into games server (215) through internet (212), the students can be able to chat online with system setting, also when proper equipment is installed for video chatting, a child can join with other friends to talk online with monitor showing actual friends image.

Children can develop friendship and teamwork to solve problems for the games and children would want to stay with the program for social gathering. This advantage can be helpful for increasing number of membership of the cyber pre-school service provider and increasing profit for the school.

The present invention provides a progressive structured learning on each curriculum for children by a software through Internet. It also provides a scientific accurate accumulative time records from the beginning to the end of each software program. Computer organizes all the progressive learning records, so it becomes simple to look at each individual's progress and check area for more supplement learning.

Children begin to recognize and learn about objects and everything around daily life when they are two or three years old. From parent's behavior, children also learn and adopt a way of life and value of life. Parents become teachers in early stage in every aspect and children develop their own personality from that stage. So it is very crucial to the childhood to help to learn, and to help to memorize all kinds of knowledge from the very beginning stage, and accordingly, the present invention provides teaching methods and steps.

Just like a brand new computer needs to be installed with all different kinds of software, it is important for human being to learn proper knowledge and moral standard from beginning because it will be effect for rest of their lives.

Therefore, to provide a good knowledge and a good character for very young children, “learning software” can be created.

The leaning software can be made when top of professionals design curriculums for each subject which the kids have to know and divide them into small lessons and each small sessions are created in games and animations for the children who do not know letters or text yet.

On the way to help children to learn and memorize the learning software, since the software is designed with games and animations when children start to play the games, the children will try to understand the subjects and will begin to memorize by playing. When subjects are described or explained in forms of animation, the effects become greater. Furthermore, the method to check the progress for individuals can be done with a calculator means of the computer when children's curriculums are divided into each subject and more divided into small sessions. For example, when 100 is perfect score to get when all the sessions are completed, computer records gives certain grades for each child's ID with the number of sessions play, the play time, and the number of sessions that are completed. Each of these gets certain value for grades and calculator mean accumulates all the scores to check the progress.

Also, when there are animations containing visual and audio effects to test children with the multiple questionnaires by a form of animation or game then computer the combines the answers, more accurate information about progress can be made and let parents to figure out what area needs to cover more.

In addition, to overcome current problems of the on-line pre-school system, the present invention improves the quality by providing online games that can be played with multiple users with visual chatting to help social life of the kids.

For the business, since the program is designed with grading system with a proper graduation certificate, make it more interesting with online games to reach out to more customers.

Eventually number of the customers will be increased with the customers who want to stay with the programs for longer time and these will become profit to the business of the pre-school service provider.

This invention also can be used for evaluating the character, the disposition and the moral standard of the human being not only kids through internet or CD with personal computer.

The database or CD can be created with a games designed to check the mental development such as the character, the disposition and morality of the player by giving different points according to the favorable action and the non-favorable action based on the mental development evaluating standard in a category of each subject for checking those points by the action of the cyber characters played in the cyber situation by the player.

The method of this invention for evaluating the mental development, and the moral standard of a human being with a game is also providing the technology for making diagnoses of a mental diseases/disorder, and for evaluating the character, the disposition and the moral standards of human being for the assignment of a position for the right man in the right post.

1. The method for checking the attendance of the cyber class through internet, comprising the step of,
(a) registering the fingerprint of registrant for completing a course of study and being issued ID number.
(b) confirming the attendance of the cyber class by inputting the registrant's fingerprint through internet;
(c) confirming the time to depart from the class by inputting the fingerprint when the registrant finishes attending a lecture;
(d) verifying the true attendance of class by the fingerprint data inputted from the registrant by comparing the fingerprint data with the fingerprint data memorized in the host computer in accordance with ID data of each registrant.

2. The method of claim 1, further comprising the step of alarming with a sound signal every set of time to the student for inputting the fingerprint, and verifying the true attendance of the cyber class by checking the fingerprint for a certain interval of the time.

3. The method of claim 1 or claim 2, further comprising the step of giving credits for the completion of the course by calculating the accumulated time of each student's log in time checked by means of fingerprint.

4. The method of claim 1 and 2, further comprising the step of creating database for each subject and lessons, and divide total running time of the program to small quantity, and when student logs-in to database with fingerprint and only views a few parts of the lesson then host computer records partial time spent and accumulates and giving credits when partial lessons are accumulating to complete lesson time which host computer recognizes as attendance.

5. The method of claim 1, wherein checking the attendance of the class through the verification of the iris of the eye, the voice signal or a passwords of the students instead of fingerprint.

6. The method of the scholastic management for granting academic degree at cyber school comprising of;
(a) calculating by the host computer the starting time and ending time of each lesson by student's fingerprint data inputted and accumulate the total logging time in the memory device of the host computer;
(b) granting credits when the host computer recognizes individual's accumulative time spent of each lesson is qualified according to the school's guide line for completion of the course;
(c) giving a qualification to the student to submit a thesis through on-line or off-line when student finishes academic requirements according to the records of credits by the host computer;
(d) granting a degree to the student when student passes all examinations concerning a thesis and complete academic cyber courses.

7. The method of claim 6, further comprising the step of giving an examination by the host computer and receiving the answer through internet to earn enough credits to graduate.

8. The method of claim 6, wherein further comprising the step of examining the thesis by attending the student on the thesis examination committee of the institute and giving the degree after the said examination.

9. The method of the scholastic management for operating the universalized university such as a cyber university or a cyber graduate school for worldwide, comprising the step of;
(a) constructing the database of the lectures in different languages comprising at least one or more different languages of the each lecture of the each professor;
(b) registering the fingerprint of the student for completing a course of study and being issued ID code;
(c) logging into the system with registered ID and selecting the lecture by the language and the professor of the database;
(d) attending the cyber class by confirming the starting time and the ending time of each lecture by inputting the student's fingerprint to check the true attendance of the cyber class;
(e) granting credits when the host computer recognizes the student's accumulative time spent of each lesson is qualified according to the school's guide line for completion of the course;
(f) giving a qualification to the student to submit a thesis through on-line or off-line when student finishes academic requirements according to the records of credits calculated by the host computer;
(g) granting a degree to the student when student passes all examinations concerning a thesis and complete academic cyber courses.

10. The educational system for operating the cyber pre-school system utilizing internet comprising the step of;
(a) a database comprising animation and/or game of each subject suitable for constructing the pre-school curriculums for the kids for studying by playing the game and/or animation;
(b) a host computer for,
(i) registering the cyber pre-school for completing a course of study by the parents and being issued ID code of the kids,
(ii) calculating the time of log-in and log-out of each subject by the ID code for recording the accumulated playing time of each subject,
(iii) qualifying the kids for completion of the program when individual's accumulative time spent of the each subject according to school's guide line, and
(iv) recognizing the kids as completion of the academic programs when the kids complete all the courses, according to the records of the host computer.

11. The educational system of claim 10, further comprising a means for registering kid's fingerprint to indicate starting time and ending time for accessing DB to check an accurate attendance.

12. The educational system of claim 10, further comprising a database of the educational curriculums such as a language course, a music course or mathematics course for issuing a certificate for completion of the said educational curriculums by recognizing the kids as completion of the course when kid's accumulative time spent of the course is qualified by the host computer.

13. The educational system of claim 10, further comprising a database of internet on-line games for providing internet on-line game service to kids for interchanging among other kids.

14. The educational system of claim 10, further comprising a database for providing internet on-line game service and a means for a visual chatting service for kids to interchange among other kids.

15. The educational system of claim 10, further registering the kids of off-line pre-school to cyber pre-school for logging into the database through internet and recognizing the completion of courses with data calculated by the host computer.

16. The business method for operating the cyber pre-school utilizing internet comprising the step of;
(a) creating a DB (database) for studying the each subject divided into session according to the pre-school curriculums;
(b) issuing ID to log in to the DB by paying the tuition;
(c) calculating the accumulated time of studying by the kids according to the time of log-in and log-out of each subject with the host computer;
(d) advising the accumulated studying time of each subject through internet to the parents to select the subject for their kids to study more according to the said accumulated learning time data of each subject;
(e) qualifying the kids for completion of the pre-school when individual's accumulative time spent of the each subject is qualified according to the guide line of the school by the host computer.

17. The business method of claim 16, further comprising a step for evaluating the development of study by calculating the signal from the kids for selecting answer among the questionnaires comprising animations or games with explanation voice.

18. The business method of claim 17, wherein the step for calculating further comprising a step for calculating the accumulated time of student's study by the subject and the number of the complete study of the subject.

19. The business method of claim 17, wherein the database is comprising educational game created to learn the subject of the pre-school curriculums for studying through playing the games.

20. The business method of claim 17, wherein the database is comprising educational animation and/or animated game created to study according to the curriculums for studying through playing the game and/or viewing animation.

21. The business method of claim 20, further comprising a cyber class created to study the subject according to the curriculums for studying through the explanation of the cyber teacher and the class activities of the characters in the cyber class.

22. The method for evaluating the mental development of a human being through internet comprising the step of,
(a) making a DB (database) of games created to evaluate the mental development such as a character, a disposition and/or a morality of a human being in a category of each checking subject;
(b) registering ID to log in the database with/without the fingerprint of the player;
(c) accessing the database with said ID with/without the fingerprint of the player and playing the games through internet;
(d) calculating the each action of the cyber characters played by the player and giving different points according to the favorable action and the non-favorable action based on the mental development evaluating standard in a category of each subject by the host computer of the DB system;
(e) advising the result of the test in a category of each checking subject, calculated by the host computer for evaluating the mental developments of the player.

23. The method of claim 22, wherein the database comprising games to check the mental development and/or knowledge of pre-school kids and evaluating the mental development and/or knowledge of the kids according to the action of the cyber characters played by kids.

24. The method of claim 22 or claim 23, wherein the DB contents comprising animated questionnaires with/without a sound explanation to be selected by the player for evaluating the mental development of the player.

25. The software system for evaluating the mental development of human being with the PC comprising,
(a) an animated game created to evaluate the player's intention according to the action of the game character in the categories of each situation through playing the game by the player;
(b) a calculating means for calculating the each action of the game characters played by the player by giving different points according to the favorable action and the non-favorable action based on the mental development evaluation standard in a category of each subject to check;
(c) a displaying means for displaying the result of the calculation by the point in a category of each subject to evaluate the mental development of the player.

26. The software system of claim 25, wherein the calculating means calculating the accumulated points in category of each subject and the number of the completion of the game to display according to the player.

27. The software system for studying the educational subjects with PC comprising, an animated game created to learn the subject through playing the game by the kids; a means for calculating the playing time of the each subject of the software by the each subject; and a means for displaying the accumulated playing time according to the subject to check the studying intensive of the kids.

28. The software system of claim 27 further comprising a cyber class created to study the subject to learn through the activities of the kids and the guidance of the teacher in the cyber class.

29. The software system of claim 27 or claim 28, further comprising a animated questionnaires for the kids to select the answer for calculating points to display on the monitor of the PC to evaluate the kid's understanding.
